(19) United States
(12) Patent Application Publication
(10) Pub. No.: US 2013/0104917 A1
(43) Pub. Date: May 2, 2013

(54) SMOKING ARTICLE HAVING TOBACCO FILTER

(71) Applicants: Vinayak Pawaskar, Maharashtra (IN); Hitendrah Shah, East Dundee, IL (US)

(72) Inventors: Vinayak Pawaskar, Maharashtra (IN); Hitendrah Shah, East Dundee, IL (US)

(73) Assignee: Twinkle, Inc., East Dundee, IL (US)

(21) Appl. No.: 13/282,013

(22) Filed: Oct. 26, 2011

(51) Int. Cl. A24D 3/08; B28B 11/14

(52) U.S. Cl. 131/331; 264/145

(57) ABSTRACT

A device for manufacturing cigar filters out of expanded Cut Rolled Stem tobacco and reconstituted tobacco is provided. The device includes a machine hopper wherein the expanded Cut Rolled Stem tobacco is added. A suction chamber the pulls the expanded Cut Rolled Stem tobacco out of the machine hopper and deposits onto a suction band to form a tobacco stream. Reconstituted tobacco is then added to the tobacco stream, which is then moved through a pencil paster that forms the tobacco stream into a cylinder and adds an adhesive. The adhesive binds the tobacco stream together into a cylindrical shape when heat is applied to activate the adhesive. A cutting section of the device cuts the cylindrical shaped tobacco stream into a desirable length for a cigar filter.

### FIELD OF THE INVENTION

This invention generally relates to cigars, and more particularly relates to cigar filters and methods of producing cigars filters.

### BACKGROUND OF THE INVENTION

A typical smoking article filter is manufactured from cellulose. Specifically, the cellulose is acetylated, dissolved, and spun as continuous synthetic fibers arranged into a bundle. The bundle is then plasticized, shaped, and cut to a length suitable to act as a filter for a cigar.

It is well known in the art that during the manufacturing of cigars the tobacco leaf is separated into the lamina and the stem portion. The lamina portion is then used to compose the smokable portion of the cigar. From an efficiency and cost savings standpoint it is desirable to use the stem portion of the tobacco leaf as well. However, this proves to be difficult because the stem tends to be harder in nature than the lamina and therefore has poorer burning qualities.

An efficient way to utilize the stem portion of the tobacco leaf is to use it as the substance of the cigar filter. There are known ways to utilize the tobacco stem product for using as the substance of a cigar filter, as shown in Patent Application Publication US 2002/0056463. As will be readily appreciated by those skilled in the art, once the present invention is understood, there are significant deficiencies existing in the prior art.

### BRIEF SUMMARY OF THE INVENTION

In one aspect, the invention provides a cigar filter manufacturing device. The manufacturing device produces cigar filters made from expanded Cut Rolled Stem (CRS) and reconstituted tobacco as opposed to the more typical cellulose material. The device comprises a machine hopper containing expanded CRS. A suction chamber that pulls the expanded CRS from the machine hopper and deposits it onto a suction band to form a tobacco stream. Once the expanded CRS is formed into a stream, reconstituted tobacco is added to the stream, which then passes under a suction wheel configured to remove excess tobacco. The tobacco stream then passes into a pencil paster where an adhesive is added and the tobacco stream is formed into a cylinder. A heater raises the temperature of the cylindrical shaped tobacco stream in order to activate the adhesive and bind the tobacco together. The device also includes a cutting section.

In another aspect, the invention provides a cigar filter composed of expanded CRS tobacco mixed with reconstituted tobacco. This combination is held together by an adhesive and formed into a cylinder.

In yet another aspect, the invention provides a method of manufacturing a cigar filter made from expanded CRS and reconstituted tobacco. This method comprises adding expanded CRS to a machine hopper and extruding the expanded CRS onto a suction band to form a tobacco stream. Reconstituted tobacco is then added to the tobacco stream. Next an adhesive is added to the tobacco mixture, which then passes through a cylindrical pencil paster. While in the pencil paster, heat is applied to the tobacco stream in order to activate the adhesive to bind the tobacco together, forming a cylindrical tobacco filter. Finally, cutting the cylindrical tobacco filter to form an individual filter element for use in a tobacco filter cigar.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cigar filter manufacturing device in accordance with an embodiment of the present invention; and

FIG. 2 is a view of a cigar in accordance with an embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

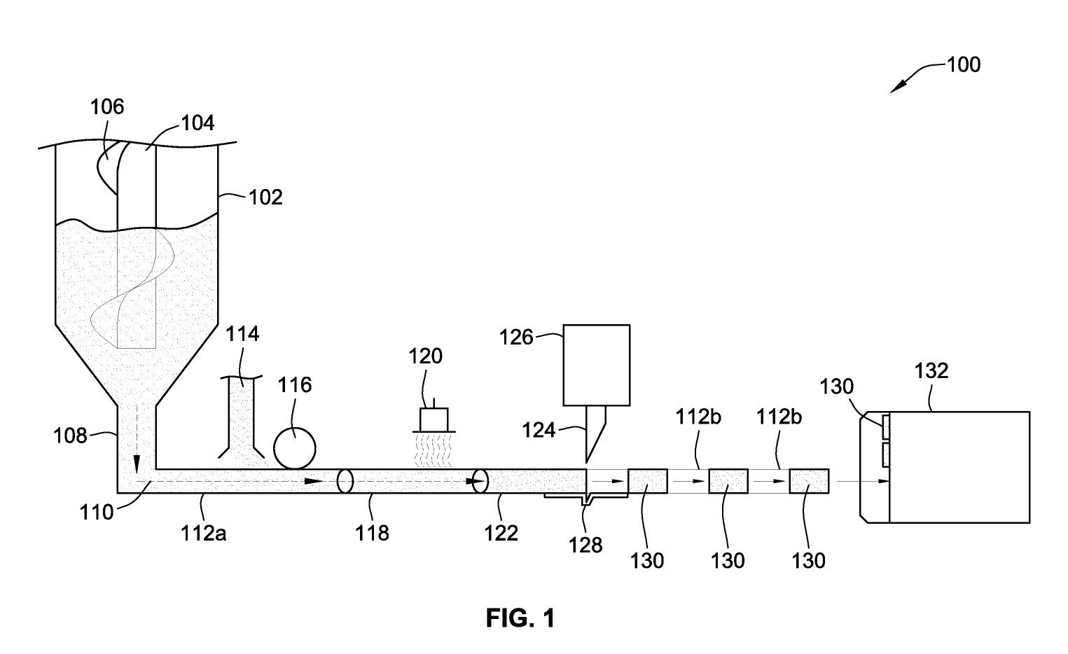

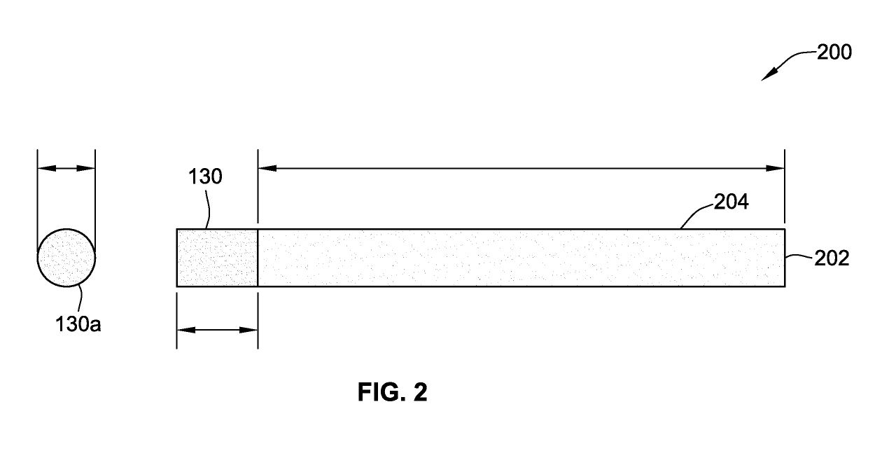

Referring to the figures, an embodiment of the invention is shown in FIG. 1. FIG. 1 is a depiction of a cigar filter manufacturing device 100. Manufacturing device 100 is used in a cigar manufacturing environment to produce a cigar filter 130 made from tobacco. Once the filter 130 is produced, it can then be used in conjunction with additional tobacco 206 wrapped in a tobacco leaf 208 to form a cigar 200, as in FIG. 2.

The cigar filter manufacturing device 100 has several components. Specifically, the device 100 includes a machine hopper 102, a mixing rod 104, a suction chamber 108, a suction band 112a, a reconstituted tobacco applicator 114, a suction wheel 116, a pencil paster 118, a rod heater 120, and a cutting section 124, 126.

Device 100 from FIG. 1 operates by adding expanded CRS into the machine hopper 102. The mixing rod 104 turns while a fin 106 on the mixing rod 104 churns the expanded CRT thereby creating a smooth even consistency with no clumps.

A suction chamber 108 applies a force pulling the expanded CRT onto a suction band 112a. The suction band 112a carries the expanded CRT past a reconstituted tobacco hopper 114 that adds reconstituted tobacco to the expanded CRT. The resulting mixture is held in place by the suction band 112a to form a tobacco stream 110. The tobacco stream 110 is passed under a suction wheel 116 to remove excess tobacco product from the tobacco stream 110.

The suction band 112a then carries the tobacco stream 110 into the pencil paster 118. The pencil paster both adds an adhesive to bind the tobacco stream together and forms the tobacco stream into a cylinder. To accomplish this task, the pencil paster 118 adds the adhesive to the tobacco stream 110 as it enters the device. In one embodiment the adhesive is an AMC2, but other adhesives such as Falcofix-IG1564 are contemplated as well.

Further, the pencil paster 118 is cylindrical in shape such that the tobacco stream is formed into a cylinder as it passes through the device. Toward the end of the pencil paster 118 a rod heater 120 is present to heat the mixture of expanded CRS, reconstituted tobacco, and adhesive. Heating the mixture activates the adhesive and binds the mixture of expanded CRS and reconstituted tobacco together into the cylindrical shape of the pencil paster 118. Filter material 122 is extruded out of pencil paster 118.

The suction band 112a carries the filter material to the cutting section, which is composed of a wafer knife 124, a ledger 126, and a counter ledger 128. The ledger 126 provides an assembly by which the wafer knife is actuated in order to cut the filter material 122 to form the individual filter elements 130.

Specifically, actuation of the ledger 126 along with the wafer knife 124 is timed with the rate of movement of the suction band in order to provide a uniform length filter element 130. Additionally, a counter ledger 128 is present to help preserve the useful life of the wafer knife 124. The counter ledger 128 acts as a cutting surface that is reciprocal to the wafer knife 124. The counter ledger 128 also helps to ensure a clean cut entirely through the filter material 122.

After the filter material 122 is cut, the individual filter elements 130 are formed. From here the individual filter elements 130 are feed into a cigar making machine's filter hopper 132 for use as filters in cigars.

FIG. 2 shows cigar 200, which is in accordance with an embodiment of the present invention. Cigar 200 has a filter 130 made by the cigar filter manufacturing device 100 (from FIG. 1). Also, cigar 200 has a tobacco portion shown as tobacco rod 206, which is the portion that is to be smoked by the user. The filter 130 acts to block loose tobacco from the tobacco rod 206 from entering a user's mouth while smoking. Additionally, cigar 200 is wrapped in a tobacco leaf wrapping 204. The wrapping 204 cover both the filter element 130 and the smokable tobacco 202.

FIG. 2 has a crossectional view of the filter element 130a. This view shows the relative diameter of the cigar 200 with respect to the length of cigar 200. In other embodiments of the present invention, the cigar filter manufacturing device 100 can be altered to cut longer or wider cigar filter elements for use in different length and types of cigars. Typically, the filter 130 is cut to a length between 9 and 30 millimeters with a diameter between 7 and 9 millimeters, and the tobacco rod 206 typically has a length between 50 and 140 millimeters with a diameter between 7 and 9 millimeters.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A smoking article, comprising:
a tobacco filter comprising shredded tobacco and adhesive binding the shredded tobacco together to prevent loose pieces of shredded tobacco from dislodging during use; and
a tobacco rod adjacent to and extending longitudinally from the tobacco filter.

2. The smoking article of claim 1, wherein the smoking article is a cigar.

3. The smoking article of claim 2, further comprising a wrapper surrounding the tobacco rod and the tobacco filter.

4. The smoking article of claim 1, wherein the tobacco filter has a length of between 9 and 30 millimeters; and a diameter between 7 and 9 millimeters; and wherein the tobacco rod has a length of between 50 and 140 millimeters and a diameter of between 7 and 9 millimeters.

5. The smoking article of claim 1, wherein the shredded tobacco comprises expanded cut roll stem (CRS) and a reconstituted tobacco mixture.

6. The smoking article of claim 1, wherein the adhesive is Falcofix-IG1564.

7. A method of making a smoking article comprising:
mixing shredded tobacco and adhesive together;
forming the shredded tobacco and adhesive into a cylinder;
cutting the cylinder to form tobacco filters.

8. The method of claim 7, wherein the shredded tobacco comprises expanded cut roll stem (CRS) and a reconstituted tobacco mixture.

9. The method of claim 7, further comprising heating the cylinder to activate the adhesive.

10. The method of claim 7, wherein the shredded tobacco and adhesive is formed into a cylinder by a pencil paster.

11. A tobacco filter for a smoking article, comprising:
shredded tobacco;
wherein the shredded tobacco is mixed with an adhesive and cylindrical in shape.

12. The tobacco filter of claim 11, wherein the shredded tobacco comprises expanded cut roll stem (CRS) and a reconstituted tobacco mixture.

13. The tobacco filter of claim 11, wherein the tobacco filter is between 9 and 30 millimeters long and has a diameter between 7 and 9 millimeters.

14. The tobacco filter of claim 11, wherein the smoking article is a cigar.
